(19) United States
(12) Patent Application Publication
(10) Pub. No.: US 2018/0207687 A1
(43) Pub. Date: Jul. 26, 2018

(54) LIQUID BLADE

(71) Applicant: Wuhan China Star Optoelectronics Technology Co., Ltd., Wuhan, Hubei (CN)

(72) Inventor: Lei XING, Shenzhen, Guangdong (CN)

(73) Assignee: Wuhan China Star Optoelectronics Technology Co., L td., Wuhan, Hubei (CN)

(21) Appl. No.: 15/123,679

(22) PCT Filed: Jul. 20, 2016
(86) PCT No.: PCT/CN2016/090627

§ 371 Date: Sep. 6, 2016

(30) Foreign Application Priority Data
Jun. 23, 2016 (CN) 2016104729039

(51) Int. Cl. B08B 3/02; G02F 1/13; B08B 3/14

(52) U.S. Cl. CPC B08B 3/022; B08B 3/042; B08B 3/14; G02F 1/1303

(57) ABSTRACT

The disclosure provides a liquid blade, the liquid blade includes water inlets, a water outlet and a waste storage groove, the water outlet is communicated with an upper section of the waste storage groove. Liquid enters the waste storage groove through the water inlets and draining through the water outlet. The liquid blade provided by the disclosure collects residue by the waste storage groove to prevent clogging of the water outlet of the liquid blade.

### FIELD OF THE DISCLOSURE

The disclosure relates to a liquid crystal panel manufacture technical field, and more particularly to a liquid blade applied to cleanse a surface of a glass substrate.

### BACKGROUND OF THE DISCLOSURE

A liquid blade made with steel use stainless (SUS) is commonly applied to cleanse a surface of a glass substrate to thereby prevent mutual contamination of a front manufacture module and a rear manufacture module in a conventional wet processing device utilized to produce a liquid crystal panel. The material of SUS is applied due to its relatively stable chemical properties, which is available in water and medicinal solution, as well as stable due to its high hardness.

A conventional design of the liquid blade is generally attaching SUS on both sides, a certain distance is remained on bottom of the attached surface to ensure liquid to flow out smoothly. The two sides of SUS are fixed by screws arranged with a constant interval between any adjacent two to guarantee uniformity and stability of the flow. The overall structure can be divided in two parts, an upper part is a water storage part and an inferior part is a water effluence part.

The design can basically fulfill a requirement of the device on water pressure and flows, but the liquid flows out through the gap between the two sides of SUS directly after being injected in the device through a liquid injection hole without a filter in-between. If a liquid injection terminal is contaminated or a tube has residue, a water effluence terminal of the liquid blade will be clogged easily, the liquid blade is frequently clogged due to absence of residue preventability, resulting in a poor process.

### SUMMARY OF THE DISCLOSURE

The disclosure provides a liquid blade to solve the problem of clogging of the liquid blade due to lack of design in preventing residue.

To solve the technical problem above, the disclosure provides a liquid blade, the liquid blade includes water inlets, a water outlet and a waste storage groove, the water outlet is communicated with an upper section of the waste storage groove. Liquid enters the waste storage groove through the water inlets and draining through the water outlet.

According to a preferred embodiment of the disclosure, the liquid blade includes a first plate and a second plate, the first plate and the second plate are clamped tightly and matched by a fixer.

According to a preferred embodiment of the disclosure, the number of the water inlets is multiple, the water inlets are disposed on the first plate.

According to a preferred embodiment of the disclosure, the water outlet is disposed below the first plate.

According to a preferred embodiment of the disclosure, a first sink is disposed on the second plate corresponding to the water inlets.

According to a preferred embodiment of the disclosure, a second sink is disposed on the second plate below the first sink.

According to a preferred embodiment of the disclosure, the second plate between the first sink and the second sink is further disposed with a flowing guide block, the flowing guide block is a plurality of oval protrusions.

According to a preferred embodiment of the disclosure, the waste storage groove is disposed below the second sink.

According to a preferred embodiment of the disclosure, two ends of the waste storage groove are further disposed with outlets.

According to a preferred embodiment of the disclosure, the second plate is further disposed with a guide plate, the guide plate is disposed below the water outlet.

To solve the technical problem above, the disclosure further provides a liquid blade, the liquid blade includes water inlets, a water outlet and a waste storage groove, the water outlets is communicated with an upper section of the waste storage groove, liquid enters the waste storage groove through the water inlets and draining through the water outlet. The liquid blade includes a first plate and a second plate, the first plate and the second plate are clamped tightly and matched by a fixer. The number of the water inlets is multiple, the water inlets are disposed on the first plate. The water outlet is disposed below the first plate. A first sink is disposed on the second plate corresponding to the water inlets. The second plate is further disposed with a guide plate, the guide plate is disposed below the water outlet.

An advantageous effect of the disclosure is that the liquid blade provided by the disclosure collects residue by the waste storage groove to prevent clogging of the water outlet of the liquid blade, which is distinguishing from the prior art.

### BRIEF DESCRIPTION OF THE DRAWINGS

In order to more clearly illustrate embodiments of the disclosure or prior art, following figures described in embodiments or prior art will be briefly introduced, it is obvious that the drawings are merely some embodiments of the disclosure, a person skilled in the art can obtain other figures according to these figures without creativity.

FIG. 1 is a schematic, cross-sectional structural view of a liquid blade according to the disclosure.

FIG. 2 is a schematic, structural view of an internal surface of a first plate of a liquid blade according to the disclosure.

FIG. 3 is a schematic, structural view of an internal surface of a second plate of a liquid blade according to the disclosure.

### DETAILED DESCRIPTION OF PREFERRED EMBODIMENTS

Embodiments of the disclosure are described in detail with reference to the accompanying drawings as follows, obviously, the described embodiments are part of embodiments of the disclosure rather than all of them. Based on the embodiments of the disclosure, all other embodiments obtained by a person skilled in the art without creativity should be considered within the scope of protection of the disclosure.

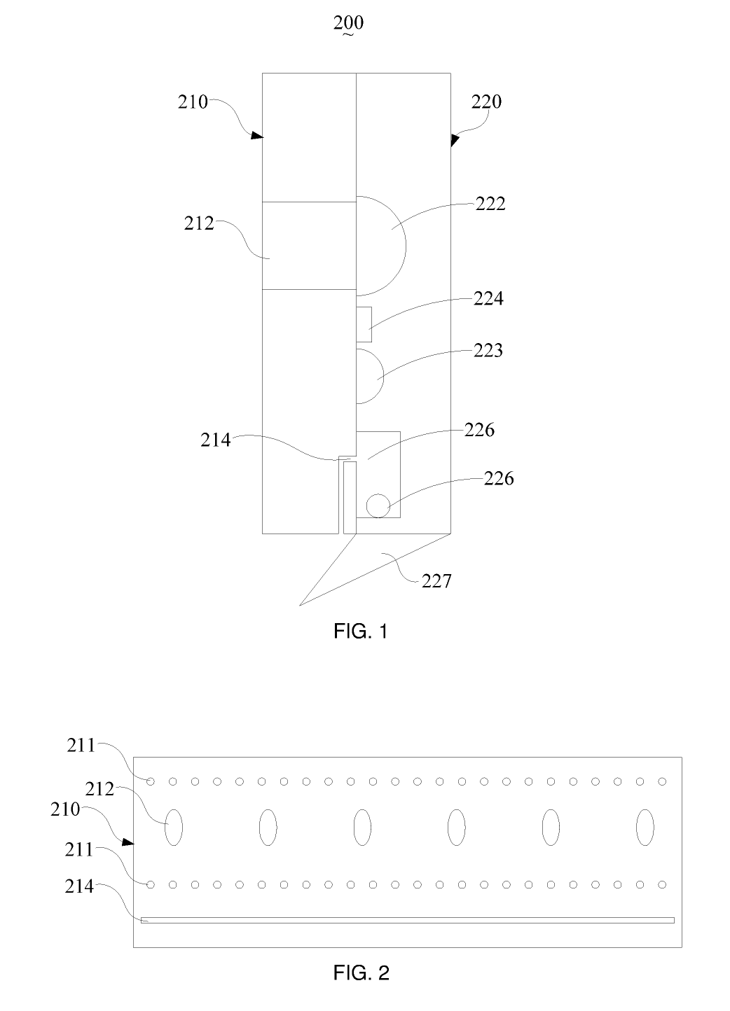

Referring to FIG. 1, FIG. 1 is a schematic, cross-sectional structural view of a liquid blade according to the disclosure.

As shown in FIG. 1, the disclosure provides a liquid blade 200, the liquid blade 200 includes a first plate 210 and a second plate 220. The first plate 210 and the second plate 220 can be clamped tightly and matched by a fixer.

Specifically, the fixer can be a screw, in a preferred embodiment, a waterproof pad can be disposed between the first plate 210 and the second plate 220 to prevent leakage.

Referring to FIG. 2 as well, FIG. 2 is a schematic, structural view of an internal surface of a first plate of a liquid blade according to the disclosure.

As shown in FIG. 2, a plurality of water inlets 212 and a water outlet 214 are disposed on the first plate 210, the water outlet 214 is disposed below the first plate 210, the first plate 210 is further disposed with a plurality of screw holes 211, positions of the plurality of screw holes 211 are merely schematic for illustrating the first plate 210 and the second plate 220 to be clamped tightly and matched by a fixer, specific positions of the screw holes are not restricted in the disclosure.

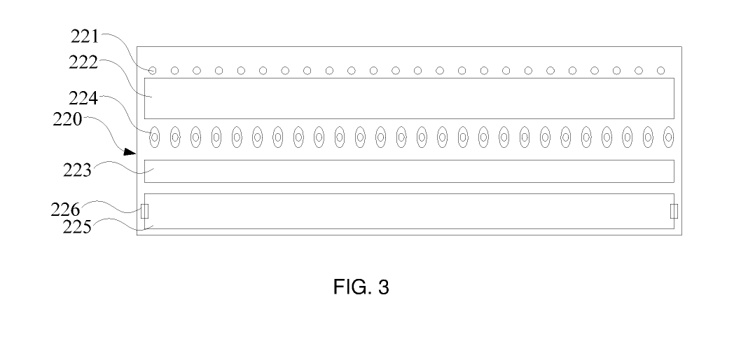

Referring to FIG. 3 as well, FIG. 3 is a schematic, structural view of an internal surface of a second plate of a liquid blade according to the disclosure.

As shown in FIG. 3, a plurality of screw holes 221, a first sink 222, a flowing guide block 224, a second sink 223, a waste storage groove 225, outlets 226 and a guide plate 227 are disposed on the second plate 220.

The plurality of screw holes 221 are corresponding to the plurality of screw holes 211 on the first plate 210.

The first sink 222 and the water inlets 212 on the first plate 210 are corresponding, liquid first enters through the water inlets 212.

The flowing guide block 224 is disposed below the first sink 222, the flowing guide block 224 is a plurality of oval protrusions. The liquid entering the first sink 222 is guided by the flowing guide block 224.

The second sink 223 is disposed below the flowing guide block 224, the liquid flows into the second sink 223 through the flowing guide block 224.

The waste storage groove 225 is disposed below the second sink 223 and communicated with the water outlet 214 on the first plate 210, the water outlet 214 is communicated with an upper section of the waste storage groove 225, when residue is remained in the liquid, the residue will deposits on bottom of the waste storage groove 225, which can clarify the liquid passing through the water outlet 214.

The outlets 226 are disposed on a side of the waste storage groove 225, which are applied to clean and unload the deposited residue in the waste storage groove 225.

The guide plate 227 is disposed below the water outlet 214, the guide plate 227 has a predetermined angle, which is applied to guide a spray direction of the liquid spraying out of the water outlet 214.

Overall, it is so well known to a person skilled in the art that the liquid blade 200 provided by the disclosure collects residue by the waste storage groove 225 to prevent clogging of the water outlet 214 of the liquid blade 200. The liquid blade 200 provided by the disclosure can ensure requirements of the device on pressure, flows and uniformity of the water, the original structure has been improved by adding a residue depositor, which can prevent clogging of the water outlet of the liquid blade 200, and the outlets 226 are reserved on two ends of the liquid blade 200 for cleansing the residue in the liquid blade 200 regularly.

Above are preferred embodiments of the disclosure, any modifications, equivalent replacements or improvements within the spirit and principles of the embodiments described above should be covered by the protected scope of the disclosure.

### INDUSTRIAL APPLICABILITY

the disclosure discloses a reformer of a system for preparing hydrogen with an aqueous solution of methanol, a system for preparing hydrogen with an aqueous solution of methanol and a method of producing hydrogen, the initiation device of the reformer is ignited by the ignition device, vaporizing the material in the heating vaporization tube and increasing combustion intensity rapidly, in order to heat the reformer, heating efficiency and speed are high, proved by a test, a restart can be done in 5 minutes, an electric heater is unnecessary in heating the initiation device of the reformer, heat efficiency is improved to the maximum extent. Therefore, it proves industrial applicability.

What is claimed is:

1. A liquid blade comprising water inlets, a water outlet and a waste storage groove, the water outlet being communicated with an upper section of the waste storage groove, liquid entering the waste storage groove through the water inlets and draining through the water outlet;
the liquid blade comprising a first plate and a second plate, the first plate and the second plate being clamped tightly and matched by a fixer;
number of the water inlets being multiple, the water inlets being disposed on the first plate;
the water outlet being disposed below the first plate;
a first sink being disposed on the second plate corresponding to the water inlets;
the second plate being further disposed with a guide plate, the guide plate being disposed below the water outlet.

2. The liquid blade according to claim 1, wherein a second sink is disposed on the second plate below the first sink.

3. The liquid blade according to claim 2, wherein the second plate between the first sink and the second sink is further disposed with a flowing guide block, the flowing guide block is a plurality of oval protrusions.

4. The liquid blade according to claim 3, wherein the waste storage groove is disposed below the second sink.

5. The liquid blade according to claim 4, wherein two ends of the waste storage groove are further disposed with outlets.

6. A liquid blade, comprising water inlets, a water outlet and a waste storage groove, the water outlets being communicated with an upper section of the waste storage groove, liquid entering the waste storage groove through the water inlets and draining through the water outlet.

7. The liquid blade according to claim 6, wherein the liquid blade comprises a first plate and a second plate, the first plate and the second plate are clamped tightly and matched by a fixer.

8. The liquid blade according to claim 7, wherein the number of the water inlets is multiple, the water inlets are disposed on the first plate.

9. The liquid blade according to claim 8, wherein the water outlet is disposed below the first plate.

10. The liquid blade according to claim 9, wherein a first sink is disposed on the second plate corresponding to the water inlets.

11. The liquid blade according to claim 10, wherein a second sink is disposed on the second plate below the first sink.

12. The liquid blade according to claim 11, wherein the second plate between the first sink and the second sink is further disposed with a flowing guide block, the flowing guide block is a plurality of oval protrusions.

13. The liquid blade according to claim 12, wherein the waste storage groove is disposed below the second sink.

14. The liquid blade according to claim 13, wherein two ends of the waste storage groove are further disposed with outlets.

15. The liquid blade according to claim 9, wherein the second plate is further disposed with a guide plate, the guide plate is disposed below the water outlet.
